(19) United States
(12) Patent Application Publication
(10) Pub. No.: US 2013/0271640 A1
(43) Pub. Date: Oct. 17, 2013

(54) IMAGE CAPTURING DEVICE

(71) Applicant: CHROMA ATE, INC., Taoyuan Hsien (TW)

(72) Inventors: CHENG YUEH-HUNG, Taoyuan Hsien (TW); CHENG Hsu-Ting, Taoyuan Hsien (TW)

(73) Assignee: CHROMA ATE, INC., Taoyuan Hsien (TW)

(21) Appl. No.: 13/803,553

(22) Filed: Mar. 14, 2013

(30) Foreign Application Priority Data
Apr. 13, 2012 (TW) 101113116

(51) Int. Cl. H04N 5/225

(52) U.S. Cl. CPC H04N 5/225
USPC 348/337

(57) ABSTRACT

An image capturing device includes a cube prism and three image capturing units. The cube prism includes an incident surface, a first exiting surface, a second exiting surface, and a third exiting surface orthogonal to each other, and further includes a first splitting surface, a second splitting surface, a third splitting surface, and a forth splitting surface orthogonal to each other. The light incident into the incident surface is split by the four splitting surfaces into monochromatic lights, and the monochromatic lights respectively exit from the three exiting surfaces to be received by the image capturing units to form images. The images can be combined as a multicolored image. Accordingly, the light-use efficiency and the image resolution can be improved, and the color fault of the image can be avoided.

### PRIORITY CLAIM

This application claims the benefit of the filing date of Taiwan Patent Application No. 101113116, filed Apr. 13, 2012, entitled “IMAGE CAPTURING DEVICE,” and the contents of which is hereby incorporated by reference in its entirety.

### FIELD OF THE INVENTION

The present invention relates to an image capturing device, and more particularly, to an image capturing device which can capture high-resolution multicolored images.

### BACKGROUND OF THE INVENTION

Automatic Optical Inspection (AOI) is a technique for detecting external structure of a device by an optical method. This technique can be classified into the following three types: one-dimensional inspection (one-dimensional bar code, displacement detection), two-dimensional inspection (pattern recognition, defect classification, two-dimensional bar code, shape measurement, thermography detection, color detection) and three-dimensional inspection (shape measurement, height detection). The technique of automatic optical inspection is applied extensively, such as quality inspection, space exploring, biomedical detection, fingerprint comparison, character recognition, machine vision and multimedia technology etc.

In general, automatic optical inspection can be applied to judge if there is a defect or if the color is correct on the surface of a semiconductor chip like an LED or solar cell. Automatic optical inspection equipment comprises an image capturing device to capture images of the surface of a semiconductor chip for digital analysing, so that users can know the status of the surface of a semiconductor chip by these images. As described above, automatic optical inspection uses images to do analysis, so the resolution and color of images are very important to the precision of automatic optical inspection.

In the prior art, an color image capturing device of automatic optical inspection equipment is a monochromatic charge coupled device (CCD) with a color filter array. This method uses corresponding pixels of the monochromatic CCD to capture various color images of an object, and then combines these images to form a multicolored image. However, in the prior art, the multicolored image is a low-resolution image because of the use of a filter. In addition, the filter also absorbs light so that the efficiency of the monochromatic CCD as well as signal to noise ratio (SNR) decline.

Please refer to FIG. 1A and FIG. 1B. FIG. 1A is a schematic diagram illustrating a color CCD array 1 according to the prior art, FIG. 1B is a schematic diagram illustrating how a color photosensitive unit 1006 of the color CCD array 1 of FIG. 1A can be used to capture images from an object 2. As shown in FIG. 1A, the color CCD array 1 is composed of a CCD photosensing array 10 and a filter array 12. When light enters, the light first passes through the filter array 12 for filtering and then can be light-sensitive by each of photosensitive units 100 of the CCD photosensing array 10. The filter array 12 comprises a green light filter 120, red light filter 122 and blue light filter 124, and these filters are arranged to corresponding photosensitive units 100 to pass green, red and blue light respectively, then, the green, red and blue light can be absorb by each of the photosensitive units 100. Thus, the color CCD array 1 comprises a green photosensitive unit 1000, a red photosensitive unit 1002 and a blue photosensitive unit 1004. In the prior art, four adjacent photosensitive units 100 and their corresponding filters make up the color photosensitive unit 1006, so the resolution of a color image declines by four times. In addition, each of the filters of the filter array 12 can only pass the corresponding monochromatic light and absorb the others, so that the light intensity to the CCD photosensing array 10 is significantly reduced.

As shown in FIG. 1B, each of monochromatic photosensitive units of the color photosensitive unit 1006 can capture images from corresponding areas of the object 2 and then combine these images to form a multicolored image. If the color of the corresponding area of the object 2 is the same with the color which can be light-sensitive by each of photosensitive units, for example, the area 20 and 26 of the object 2 are green, the area 22 is red and the area 24 is blue, the color of the image captured by the color photosensitive unit 1006 is different to the color of the object 2 because each of the photosensitive units of the color photosensitive unit 1006 can receive light so that the color of the combined image captured by the color photosensitive unit 1006 is white.

For this reason, it is necessary to design a new image capturing device which can capture high-resolution multicolored images and avoid wrong color situations.

### SUMMARY OF THE INVENTION

Accordingly, the present invention is to provide an image capturing device to solve the problem of the prior art.

According to an embodiment of the invention, the image capturing device of the invention comprises a cube prism, a first image capturing unit, a second image capturing unit and a third image capturing unit. The cube prism comprises an incident surface, a first exiting surface, a second exiting surface and a third exiting surface orthogonal to each other. The cube prism further comprises a first splitting surface, a second splitting surface, a third splitting surface and a forth splitting surface orthogonal to each other. The incident surface is used for receiving an incident light. The first image capturing unit, the second image capturing unit and the third image capturing unit are faced with the first exiting surface, the second exiting surface and the third exiting surface respectively for receiving the light emitted from these three exiting surfaces.

In this embodiment, the incident light entering the incident surface is split into at least one monochromatic light through the first splitting surface, the second splitting surface, the third splitting surface and the forth splitting surface, and the monochromatic light exits from the first exiting surface, the second exiting surface and the third exiting surface respectively to be received by the first image capturing unit, the second image capturing unit and the third image capturing unit. These three image capturing units can form images after receiving the monochromatic light respectively and then the images can be combined to a multicolored image. With the image capturing device of this embodiment, the light-use efficiency and the image resolution can be improved, and the color fault of the image can be avoided.

Many other advantages and features of the present invention will be further understood by the following detailed description and the appended drawings.

### BRIEF DESCRIPTION OF THE DRAWINGS

FIG. 1A is a schematic diagram illustrating a color CCD array according to the prior art.

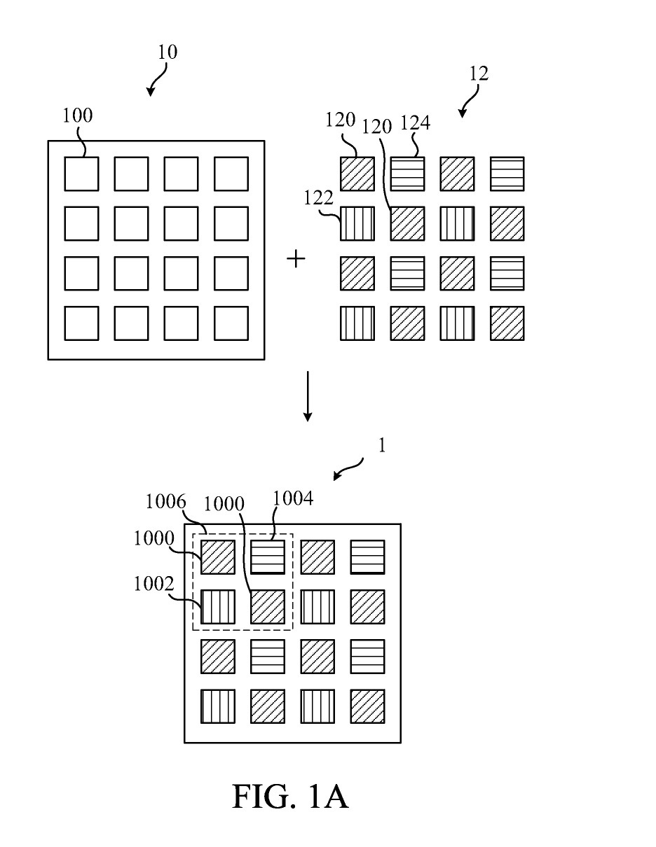

FIG. 1B is a schematic diagram illustrating how a color photosensitive unit of the color CCD array of FIG. 1A can be used to capture images from an object.

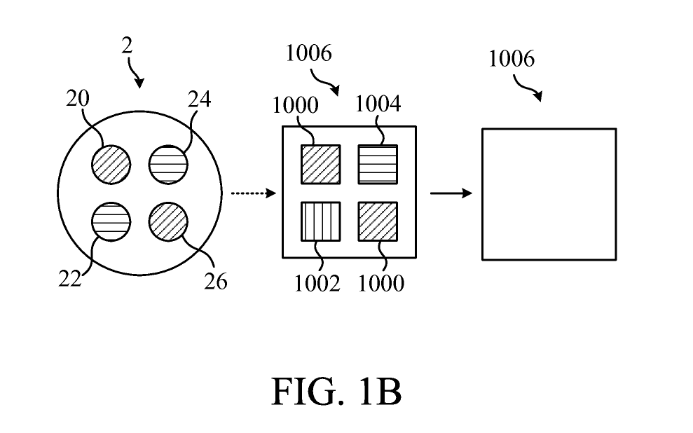

FIG. 2 is a schematic diagram illustrating an image capturing device according to an embodiment of the invention.

FIG. 3 is a schematic diagram illustrating the light path when the image capturing device of FIG. 2 is capturing a image.

To facilitate understanding, identical reference numerals have been used, where it is possible to designate identical elements that are common to the figures.

### DETAILED DESCRIPTION

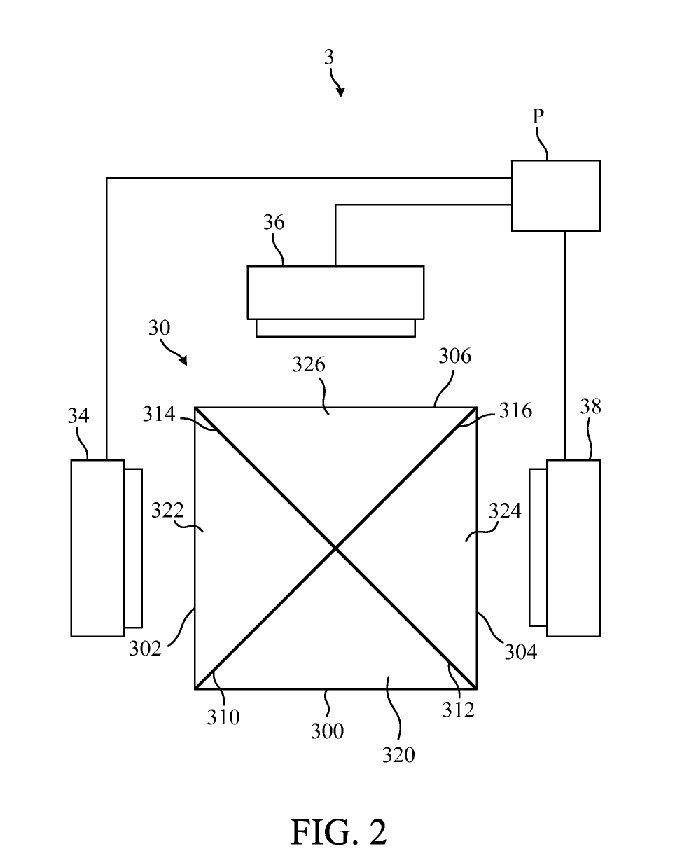

Please refer to FIG. 2. FIG. 2 is a schematic diagram illustrating an image capturing device 3 according to an embodiment of the invention. The image capturing device 3 can be used to capture images of the surface of a semiconductor chip for digital analysing, so that users can know the status of the surface of a semiconductor chip by these images.

As shown in FIG. 2, the image capturing device 3 comprises a cube prism 30, wherein the outside of the cube prism 30 comprises an incident surface 300, a first exiting surface 302, a second exiting surface 304 and a third exiting surface 306, moreover, the incident surface 300, the first exiting surface 302, the second exiting surface 304 and the third exiting surface 306 are orthogonal to each other. In addition, the inside of the cube prism 30 comprises the first splitting surface 310, the second splitting surface 312, the third splitting surface 314 and the forth splitting surface 316 orthogonal to each other.

In this embodiment, the cube prism 30 further comprises a first right angle prism 320, a second right angle prism 322, a third right angle prism 324 and a forth right angle prism 326, every two orthogonal surfaces are close to each other to form the cube prism 30. In detail, the first right angle prism 320 is close to the second right angle prism 322 and the third right angle prism 324 respectively to form the first splitting surface 310 and the second splitting surface 312, the forth right angle prism 326 is close to the second right angle prism 322 and the third right angle prism 324 respectively to form the third splitting surface 314 and the forth splitting surface 316. In this way, the 45° surface between the two orthogonal surfaces of the first right angle prism 320 is the incident surface 300. Similarly, the second right angle prism 322, the third right angle prism 324 and the forth right angle prism 326 respectively comprise the first exiting surface 302, the second exiting surface 304 and the third exiting surface 306.

The incident surface 300 of the cube prism 30 is used for receiving light, which is reflected by an object illuminated by ambient light or a lighting device (not illustrated in the appended drawings) of the image capturing device 3. Each of the splitting surfaces has a different filtering layer so as to have a splitting effect. In this embodiment, the first splitting surface 310 has a first low pass filtering layer, the second splitting surface 312 has a first high pass filtering layer, the third splitting surface 314 has a second high pass filtering layer, the forth splitting surface 316 has a second low pass filtering layer. In practice, the above filtering layers can be dielectric filter coating.

Please refer to FIG. 2 again, the image capturing device 3 further comprises a first image capturing unit 34, a second image capturing unit 36 and a third image capturing unit 38, each of the image capturing units is respectively faced with the first exiting surface 302, the second exiting surface 304 and the third exiting surface 306. In this embodiment, each of the image capturing units comprises an image sensor for receiving light and forming images. The image sensor can be charge-coupled device (CCD) or complementary metal-oxide-semiconductor (CMOS). The pixel position of the image sensor of the first image capturing unit 34, the second image capturing unit 36 and the third image capturing unit 38 are corresponded with each other so that the pixels of the images from each of the image capturing units correspond with each other.

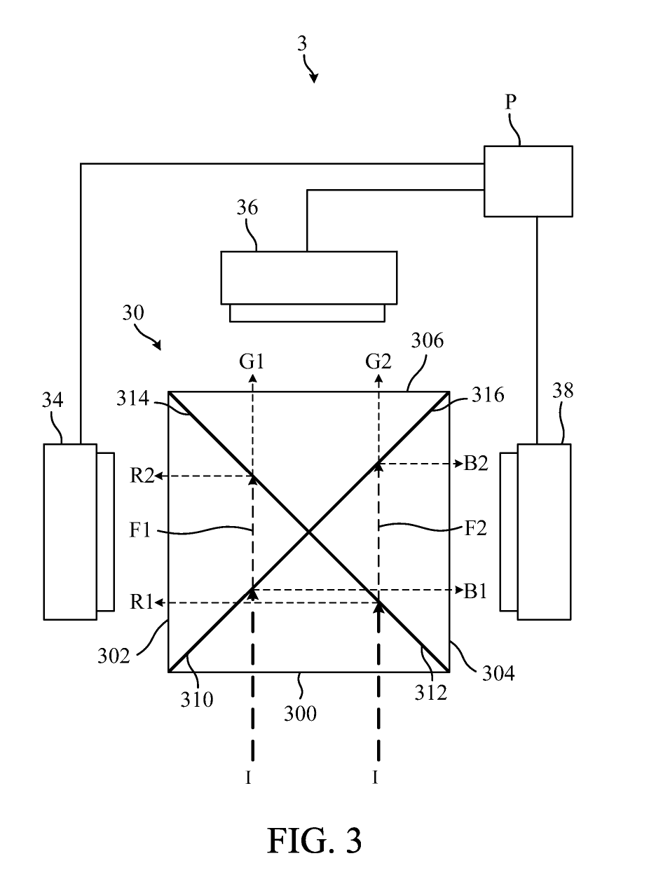

Please refer to FIG. 3. FIG. 3 is a schematic diagram illustrating the light path when the image capturing device of FIG. 2 is capturing an image. As shown in FIG. 3, an incident light I is the light reflected by an object and going through the incident surface 300. When the incident light I reaches the first splitting surface 310, a first low pass filtering layer of the first splitting surface 310 passes a low-frequency light of the incident light I and reflects a high-frequency light of the incident light I to the second splitting surface 312. In this embodiment, the frequency of the light reflected by the first low pass filtering layer is based on the frequency of blue light. In other words, the first splitting surface 310 reflects a high-frequency blue light B1 of the incident light I and passes a low-frequency first filtering light F1 of the incident light I.

Alternatively, the frequency of the light reflected by a first high pass filtering layer of the second splitting surface 312 is based on the frequency of red light. Thus, when the incident light I reaches the second splitting surface 312, the first high pass filtering layer reflects a low-frequency red light R1 and passes a high-frequency second filtering light F2. Additionally, because the second splitting surface 312 can pass high-frequency light, the high-frequency blue light B1 reflected by the first splitting surface 310 can pass through the second splitting surface 312 and emit from the second exiting surface 304. Similarly, the low-frequency red light R1 reflected by the second splitting surface 312 can pass through the first splitting surface 310 and emit from the first exiting surface 302.

When the first filtering light F1 passes through the first splitting surface 310 and reaches the third splitting surface 314, a second high pass filtering layer of the third splitting surface 314 can split the first filtering light F1 again. In this embodiment, the frequency of the light reflected by the second high pass filtering layer is based on the frequency of red light. Thus, the third splitting surface 314 can reflect a low-frequency red light R2 of the first filtering light F1 to the first exiting surface 302 and pass high-frequency light of the first filtering light F1 to the third exiting surface 306. By reflecting blue light of the incident light I with the first splitting surface 310, the first filtering light F1 only comprises green and red light, so that only a high-frequency green light G1 of the first filtering light F1 can pass the third splitting surface 314.

Additionally, by reflecting the low-frequency red light R1 of the incident light I with the second splitting surface 312, the second filtering light F2 only comprises green and blue light. The frequency of the light reflected by the second low pass filtering layer of the forth splitting surface 316 is based on the frequency of blue light. Thus, when the second filtering light F2 reaches the forth splitting surface 316, a blue light B2 be reflected to the second exiting surface 304 and a green light G2 passes through the forth splitting surface 316 to the third exiting surface 306. According to the above, the incident light I can be split into red, blue and green lights with the first splitting surface 310, the second splitting surface 312, the third splitting surface 314 and the forth splitting surface 316. These three monochromatic lights emit from the first exiting surface 302, the second exiting surface 304 and the third exiting surface 306 respectively. In practice, the incident light I does not exactly comprise of all three of these monochromatic lights but maybe comprise of parts of these three monochromatic lights. For example, if the incident light I is a white light, the three exiting surfaces of the cube prism 30 can emit three different monochromatic lights, however, if the incident light I is a reddish light, there are only the first exiting surface 302 and the third exiting surface 306 which emit monochromatic lights (red and green light).

According to the above, the first image capturing unit 34, the second image capturing unit 36 and the third image capturing unit 38 respectively receive the monochromatic lights emitted from the first exiting surface 302, the second exiting surface 304 and the third exiting surface 306 by their image sensors and form monochrome images. Since these monochrome images are formed from split monochromatic lights of the incident light I, a multicolored image can be obtained by combining these monochrome images. In this embodiment, the pixel position of the image sensor of the first image capturing unit 34, the second image capturing unit 36 and the third image capturing unit 38 correspond with each other so that the pixels of the images from each of the image capturing units correspond with each other. Thus, these images can be combined to form a multicolored image. In practice, each of the image capturing units can further comprise a monochromatic filter to prevent the light with other colors from entering the image sensor to cause a color fault. For example, the first image capturing unit 34 can further have a red light filter to prevent blue or green light from entering the image sensor.

Please refer to FIG. 2 and FIG. 3 again. The image capturing device 3 can further comprises a processor P connected with the first image capturing unit, the second image capturing unit and the third image capturing unit. The processor P can transmit a triggering signal to these three image capturing units so that the three image capturing units capture images synchronously. The processor P can also receive monochrome images from the three image capturing units and combine the pixels with the corresponding pixels of the images to form the multicolored image.

Each of the splitting surfaces as well as the exiting surfaces of the cube prism 30 is orthogonal to each other. Additionally, the angle between each of the splitting surfaces and each of the exiting surfaces is 45°. With the above arrangement, the incident light I through the incident surface 300 can be split into monochromatic lights, then, these monochromatic lights emit from each of the exiting surfaces respectively and are received by each of the image capturing units. According to the above, the combined multicolored image can have better quality. In practice, when it comes to mechanism, the cube shape of the prism is easier to be designed in the image capturing device. Furthermore, it is good for the combination of the multicolored image because the light paths of monochromatic lights are the same.

The monochrome images from the first image capturing unit 34, the second image capturing unit 36 and the third image capturing unit 38 of this embodiment are combined by superposing the pixels with the corresponding pixels, so the image resolution of the invention is much higher than the image resolution of the prior art. For example, if the resolution of the image sensor is 800×600, the resolution of the multicolored image from the image capturing device 3 of this invention is 800×600 also, however, the resolution of the prior art is 200×125 in this situation. In addition, because there is a one-to-one correspondence between pixels and the object, the color fault of the prior art can be avoided in this invention.

Alternatively, the low pass filtering layers or the high pass filtering layers of the splitting surfaces of the cube prism 30 reflect or pass monochromatic lights to the exiting surfaces, in other words, all of the incident light I can be used to form the monochrome images. Compared to the color filter array, without absorbing much light, the cube prism 30 with the low pass filtering layers and the high pass filtering layers make the multicolored image have a better signal to noise ratio (SNR).

According to the above, the image capturing device of the invention comprises a cube prism having mutually orthogonal splitting surfaces and mutually orthogonal exiting surfaces. When the incident light reflected from an object reaches an incident surface of the cube prism, the incident light is split into monochromatic lights by each of the splitting surfaces. Then, these monochromatic lights emit from each of the exiting surfaces. The image capturing device further comprises image capturing units to receive monochromatic lights emitted from each of the exiting surfaces and form monochrome images. Then, a processor combines these monochrome images into a multicolored image. By the combination of these monochrome images, the color fault of the prior art can be avoided in this invention, further, the resolution of the multicolored image can be improved also.

With the example and explanations above, the features and spirits of the invention will be hopefully well described. Importantly, the present invention is not limited to the embodiment described herein. Those skilled in the art will readily observe that numerous modifications and alterations of the device may be made while retaining the teaching of the invention. Accordingly, the above disclosure should be construed as limited only by the metes and bounds of the appended claims.

1. An image capturing device, for receiving an incident light to form a multicolored image, the image capturing device comprising:
a cube prism having an incident surface, a first exiting surface, a second exiting surface, and a third exiting surface orthogonal to each other, and the cube prism further having a first splitting surface, a second splitting surface, a third splitting surface, and a forth splitting surface orthogonal to each other;
a first image capturing unit, faced with the first exiting surface to receive the light from the first exiting surface;
a second image capturing unit, faced with the second exiting surface to receive the light from the second exiting surface; and
a third image capturing unit, faced with the third exiting surface to receive the light from the third exiting surface;
wherein, the incident light entering the incident surface is split into at least one monochromatic light through the first splitting surface, the second splitting surface, the third splitting surface and the forth splitting surface, and the monochromatic light exits from the first exiting surface, the second exiting surface and the third exiting surface respectively.

2. The image capturing device of claim 1, wherein the first image capturing unit, the second image capturing unit and the third image capturing unit respectively comprise an image sensor to receive the at least one monochromatic light to capture images.

3. The image capturing device of claim 2, wherein the pixel position of the image sensor of the first image capturing unit, the second image capturing unit and the third image capturing unit correspond with each other, so that the pixels of the images from each of the image capturing units can correspond with each other.

4. The image capturing device of claim 3, wherein the first image capturing unit, the second image capturing unit and the third image capturing unit capture images synchronously according to a triggering signal.

5. The image capturing device of claim 3, further comprising a processor electrically connected to the first image capturing unit, the second image capturing unit and the third image capturing unit for combining the images from the first image capturing unit, the second image capturing unit and the third image capturing unit to form the multicolored image.

6. The image capturing device of claim 5, wherein the processor combines the pixels with the corresponding pixels of the images from each of the image capturing units to form the multicolored image.

7. The image capturing device of claim 1, wherein the cube prism comprises a first right angle prism, a second right angle prism, a third right angle prism and a forth right angle prism, the first right angle prism being close to the second right angle prism and the third right angle prism respectively to form the first splitting surface and the second splitting surface, the forth right angle prism being close to the second right angle prism and the third right angle prism respectively to form the third splitting surface and the forth splitting surface, the first right angle prism, the second right angle prism, the third right angle prism and the forth right angle prism respectively having the incident surface, the first exiting surface, the second exiting surface and the third exiting surface.

8. The image capturing device of claim 7, wherein the first splitting surface has a first low pass filtering layer to reflect a blue light of the incident light to the second exiting surface and pass a first filtering light of the incident light, the second splitting surface has a first high pass filtering layer to reflect a red light of the incident light to the first exiting surface and pass a second filtering light of the incident light.

9. The image capturing device of claim 8, wherein the third splitting surface has a second high pass filtering layer to reflect a red light of the first filtering light to the first exiting surface and pass a green light of the first filtering light to the third exiting surface, the forth splitting surface has a second low pass filtering layer to reflect a blue light of the second filtering light to the second exiting surface and pass a green light of the second filtering light to the third exiting surface.
